(19) United States
(12) Patent Application Publication
(10) Pub. No.: US 2017/0358915 A1
(43) Pub. Date: Dec. 14, 2017

(54) INTERRUPTING DEVICE

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP)

(72) Inventor: Yuuki Sugisawa, Yokkaichi, Mie (JP)

(73) Assignees: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP)

(21) Appl. No.: 15/541,249

(22) PCT Filed: Jan. 6, 2016
(86) PCT No.: PCT/JP2016/050230

§ 371 Date: Jun. 30, 2017

(30) Foreign Application Priority Data
Jan. 20, 2015 (JP) 2015-008792

(51) Int. Cl. H02H 3/087; H02H 1/00

(52) U.S. Cl. CPC H02H 3/087; H02H 1/0007

(57) ABSTRACT

An interrupting device is provided with a P-channel FET in a current path from a battery to a load. A current mirror circuit draws in current from each of the source side and the drain side of the FET and outputs a current obtained by combining the two drawn-in currents. The higher a value Id of the current flowing to the FET is, the higher the values Ic of the two currents drawn in by the current mirror circuit are. A switching circuit switches the FET off in the case where the value of the current output from the current mirror circuit is greater than or equal to a current threshold. As a result, if a current that is greater than or equal to the current threshold flows along the current path from the battery to the load, the current flowing along that current path is interrupted.

### CROSS-REFERENCE TO RELATED APPLICATIONS

This application is the U.S. national stage of PCT/JP2016/050230 filed Jan. 6, 2016, which claims priority of Japanese Patent Application No. JP 2015-008792 filed Jan. 20, 2015.

### TECHNICAL FIELD

The present invention relates to an interrupting device that interrupts a current flowing in a current path in order to prevent overcurrent from flowing in the current path.

### BACKGROUND

A vehicle includes a power source device that, by switching off a switch provided in a current path from a battery to a load, prevents overcurrent from flowing in the current path (see JP 2014-34291A, for example).

FIG. 1 is a circuit diagram illustrating a conventional power source device 8. According to the conventional power source device 8 described in JP 2014-34291A, the positive terminal of a battery 80 is connected to one end of a load 81 via a switch 82, whereas the negative terminal of the battery 80 and the other end of the load 81 are grounded.

A switch 83 is a PNP bipolar transistor, and a switch 84 is an NPN bipolar transistor. Regarding the switch 83, the emitter is connected to the positive terminal of the battery 80, the collector is connected to one end of the load 81 and one end of a resistor Ra, and the base is connected to one end of a resistor Rb. The other end of the resistor Ra is connected to the base of the switch 84, one end of a switch 85, and one end of a resistor Rc. The collector of the switch 84 is connected to the other end of the resistor Rb. The emitter of the switch 84, the other end of the switch 85, and the other end of the resistor Rc are grounded.

According to the conventional power source device 8, the switches 82, 83, 84, and 85 are off, on, on, and off, respectively, in the case where the load 81 is stopped.

Because the switch 82 is off, current flows from the positive terminal of the battery 80 to the switch 83 and the resistors Ra and Rc in order. The resistors Ra and Rc divide the output voltage of the battery 80, and the divided voltage is applied to the base of the switch 84. As a result, current flows from the base to the emitter of the switch 84 such that the switch 84 stays on.

In the case where the switch 84 is on, current flows from the positive terminal of the battery 80 to the emitter and the base of the switch 83 in order. Current flows from the base of the switch 83 to the resistor Rb and the switch 84 in order. As a result, the switch 83 also stays on. The battery 80 supplies dark current to the load 81 via the switch 83.

In the case where the load 81 has shorted, a value Ia of the current flowing in the resistor Ra goes to zero amperes. The voltage difference between the base and the emitter of the switch 84 goes to zero volts as a result, and thus no current flows from the base to the emitter, which switches the switch 84 off. In the case where the switch 84 has been switched off, a value Ib of the current flowing in the resistor Rb, or in other words, the value of the current flowing from the emitter to the base of the switch 83, goes to zero amperes. As a result, the switch 83 is also switched off. As a result, overcurrent is prevented from flowing from the battery 80 to the load 81 via the switch 83.

Based on the above, the circuit constituted of the switches 83, 84, and 85 and the resistors Ra, Rb, and Rc functions as an interrupting device that, by switching the switch 83 off, interrupts current flowing in the current path from the battery 80 to the load 81 so as to prevent overcurrent from flowing in the current path.

However, in the conventional power source device 8, a constant current continues to flow to both the resistors Ra and Rb while the load 81 is stopped, regardless of the value of the current supplied to the load 81. The resistors Ra, Rb, and Rc thus continue to consume power. There is thus a problem in that the circuit functioning as an interrupting device has high power consumption.

Having been achieved in light of such circumstances, an object of the present invention is to provide an interrupting device having low power consumption.

### SUMMARY

An interrupting device according to the present invention is an interrupting device that, in the case where a current greater than or equal to a predetermined value flows in a current path, interrupts the current flowing in the current path. The device includes: a switch provided in the current path; a current mirror circuit that draws in a current from each of one end and another end of the switch and outputs a current obtained by combining the two drawn-in currents; and a switching circuit that switches the switch off in the case where a value of the current outputted from the current mirror circuit is greater than or equal to a current threshold. A value of each of the two currents drawn in by the current mirror circuit is higher the higher a value of the current flowing in the switch is.

According to the present invention, the switch is provided in the current path. The current mirror circuit draws in the current from each of the one end and the other end of the switch and outputs a current obtained by combining the two drawn-in currents. The value of each of the two currents drawn in by the current mirror circuit is higher the higher the value of the current flowing in the switch is. In the case where the current flowing in the current path is greater than or equal to the predetermined value, the value of the current outputted from the current mirror circuit becomes greater than or equal to the current threshold, and the switching circuit switches the switch off so as to interrupt the current flowing in the current path.

As a result, overcurrent is prevented from flowing in the current path. Furthermore, because the values of the two currents drawn in by the current mirror circuit are greater the greater the value of the current flowing in the switch is, the value of the current flowing through the current mirror circuit will be low in the case where the value of the current flowing in the current path is low. Accordingly, for example, in the case where the current path is a current path from a battery to a load, the load consumes almost no power when not operating, and thus the device also consumes almost no power. Thus the amount of power consumed is low.

In the interrupting device according to the present invention, the switching circuit is configured to keep the switch off after switching the switch off regardless of the value of the current outputted by the current mirror circuit, and the interrupting device further includes a canceling unit that cancels the off state the switch is kept in.

According to the present invention, no current flows in the switch in the case where the switching circuit has switched the switch off, and thus the value of the current outputted by the current mirror circuit drops. However, the switching circuit keeps the switch off regardless of the value of the current outputted by the current mirror circuit. In the case where, for example, a signal for canceling this off state has been inputted to the device, the off state of the switch, kept by the switching circuit, is canceled.

As described above, the switch is kept off, and thus overcurrent is prevented from continuing to flow in the current path. Furthermore, canceling the off state of the switch being kept makes it possible for current to flow in the current path again.

In the interrupting device according to the present invention, the switch is a transistor, and is configured to enter a non-conductive state in the case where a voltage value at a control terminal that takes a potential at a current input terminal as a reference is greater than or equal to a voltage threshold less than zero, and to enter a conductive state in the case where the voltage value at the control terminal is less than the voltage threshold.

In the present invention, the switch is a transistor, for example a P-channel Field Effect Transistor (FET). In the switch, in the case where the voltage value at a control terminal, such as a gate, that takes the potential at a current input terminal, such as a source, as a reference, is greater than or equal to a voltage threshold less than zero, the switch enters a non-conductive state and is switched off. Additionally, in the switch, in the case where the voltage value at the control terminal that takes the potential at the current input terminal as a reference is less than the voltage threshold, the switch enters a conductive state and is switched on.

Accordingly, by keeping the voltage between the current input terminal and the control terminal at zero volts or substantially zero volts, the switch can be kept on, and it is not necessary to keep the potential at the control terminal at a potential greater than the potential at the current input terminal using a charge pump circuit, for example. The amount of power consumed is therefore low.

The interrupting device according to the present invention further includes a resistance circuit, having at least one resistor, in which the current outputted by the current mirror circuit flows, and the switching circuit is configured to switch the switch off in the case where a voltage value at both ends of the resistance circuit is greater than or equal to a second voltage threshold.

According to the present invention, the current outputted by the current mirror circuit flows in the resistance circuit, which has at least one resistor. Accordingly, the voltage value between both ends of the resistance circuit is higher the higher the value of the current outputted by the current mirror circuit is. In the case where the current outputted by the current mirror circuit is greater than or equal to the current threshold, the voltage value between both ends of the resistance circuit becomes greater than or equal to the second voltage threshold, and the switching circuit switches the switch off. A configuration in which the current flowing in the current path is interrupted in the case where a current greater than or equal to the predetermined value flows in the current path can thus be realized easily.

In the interrupting device according to the present invention, the resistance circuit includes a first resistor, and a series circuit, constituted of a second resistor and a capacitor, connected in parallel to the first resistor.

According to the present invention, in the resistance circuit, a series circuit constituted of the second resistor and the capacitor is connected in parallel to the first resistor. In the case where no power is stored in the capacitor, the resistance value of the resistance circuit is substantially the resistance value of the parallel circuit constituted of the first resistor and the second resistor. As the power stored in the capacitor increases, the resistance value of the resistance circuit rises and approaches the resistance value of the first resistor.

A load to which a large current is temporarily supplied during operation can be considered as the load to which current is supplied via the current path. In this case, a low amount of power is stored in the capacitor, and the resistance value of the resistance circuit is low, at the point in time when the load operated. Accordingly, even in the case where the load has operated and a large current has temporarily flows in the current path, the voltage between both ends of the resistance circuit will not become greater than or equal to the voltage threshold, and the switch will not be switched off.

In the interrupting device according to the present invention, the switching circuit is configured to output an interruption signal indicating the interruption of the current flowing in the current path in the case where the switch has been switched off.

According to the present invention, in the case where the switch has been switched off, the interruption signal indicating the interruption of the current flowing in the current path is outputted from the switching circuit, and thus a notification that the current flowing in the current path has been interrupted, for example, can be made.

### Advantageous Effects of Invention

According to the present invention, the value of a current outputted by a current mirror circuit is greater the greater the value of a current flowing in a switch is, and thus the amount of power consumed is low.

### BRIEF DESCRIPTION OF DRAWINGS

FIG. 1 is a circuit diagram illustrating a conventional power source device.

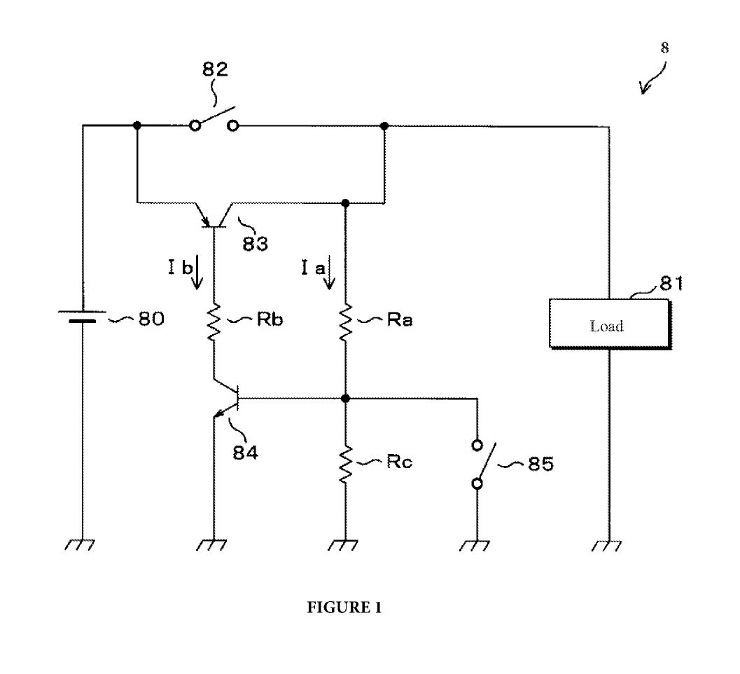

FIG. 2 is a block diagram illustrating the configuration of primary components of a power source device according to a first embodiment.

FIG. 3 is a circuit diagram illustrating an interrupting device.

FIG. 4 is a timing chart illustrating operations of the interrupting device.

FIG. 5 is a circuit diagram illustrating an interrupting device according to a second embodiment.

FIG. 6 is a timing chart illustrating effects of a resistance circuit.

### DETAILED DESCRIPTION OF PREFERRED EMBODIMENTS

The present invention will be described in detail hereinafter on the basis of drawings illustrating embodiments thereof.

### First Embodiment

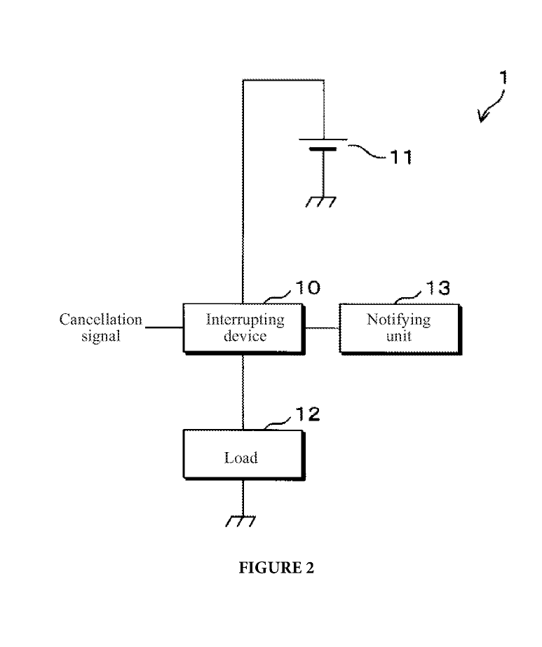

FIG. 2 is a block diagram illustrating the configuration of primary components of a power source device 1 according to a first embodiment. The power source device 1 is preferably installed in a vehicle, and includes an interrupting device 10, a battery 11, a load 12, and a notifying unit 13. The interrupting device 10 is connected to a positive terminal of the battery 11, one end of the load 12, and the notifying unit 13. A negative terminal of the battery 11 and the other end of the load 12 are grounded.

The load 12 is an electrical device installed in the vehicle, and power is supplied to the load 12 from the battery 11 via the interrupting device 10. The load 12 consumes a set amount of power while operating, and thus a set current flows to the load 12. When stopped, the load 12 consumes almost no power, and thus the value of current flowing in the load 12 is zero amperes or substantially zero amperes.

The interrupting device 10 is configured so that the battery 11 can normally supply power to the load 12. In the case where current greater than or equal to a predetermined value flows in the current path from the battery 11 to the load 12, the interrupting device 10 interrupts the current flowing in the current path. In the case where the interrupting device 10 has interrupted the current, the interrupting device 10 outputs, to the notifying unit 13, an interruption signal indicating that the current flowing in the current path from the battery 11 to the load 12 has been interrupted.

The notifying unit 13 is inputted with the interruption signal from the interrupting device 10. In the case where the notifying unit 13 has been inputted with the interruption signal from the interrupting device 10, the notifying unit 13 makes a notification. The notifying unit 13 makes the notification by displaying, in a display unit (not illustrated), a message indicating that the current flowing in the current path from the battery 11 to the load 12 has been interrupted, for example.

A cancellation signal for canceling the interruption of the current flowing in the current path from the battery 11 to the load 12 is inputted to the interrupting device 10. The cancellation signal is a binary signal having a high-level voltage and a low-level voltage. In the case where the cancellation signal is at the low-level voltage, the interrupting device 10 maintains the current interrupted or non-interrupted state of the current. In the case where the interrupting device 10 is in an interrupting state, and the cancellation signal switches from the low-level voltage to the high-level voltage, the interrupting device 10 cancels the interruption of the current.

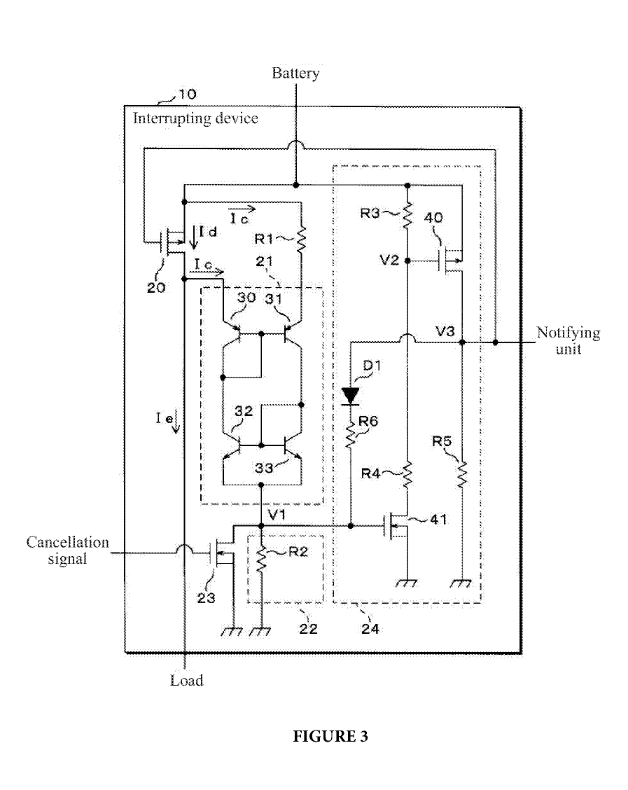

FIG. 3 is a circuit diagram illustrating the interrupting device 10. The interrupting device 10 includes a P-channel FET 20, a current mirror circuit 21, a resistance circuit 22, an N-channel FET 23, a switching circuit 24, and a resistor R1. Each of the FETs 20 and 23 has a drain, a source, and a gate as terminals. The source of the FET 20 is connected to the positive terminal of the battery 11, and the drain of the FET 20 is connected to one end of the load 12. The source of the FET 20 is further connected to one end of the resistor R1. The drain of the FET 20 and the other end of the resistor R1 are individually connected to the current mirror circuit 21.

The current mirror circuit 21 is further connected to one end of the resistance circuit 22. The one end of the resistance circuit 22 is further connected to the drain of the FET 23. The other end of the resistance circuit 22 and the source of the FET 23 are grounded.

The switching circuit 24 is connected individually to the positive terminal of the battery 11, the gate of the FET 20, and the one end of the resistance circuit 22. The gate of the FET 20 is also connected to the notifying unit 13.

The FET 20 functions as a switch, and is provided in the current path from the battery 11 to the load 12. In the FET 20, current flows from the source to the drain. The FET 20 enters a non-conductive state and is switched off in the case where a voltage value at the gate, which takes the potential of the source as a reference, is greater than or equal to a predetermined voltage threshold, which is less than zero volts. Meanwhile, the FET 20 enters a conductive state and is switched on in the case where the voltage value at the gate, which takes the potential of the source as a reference, is less than the voltage threshold. The gate functions as a control terminal, and the source functions as a current input terminal.

In the case where the FET 20 is on, current can flow from the battery 11 to the load 12, and thus the battery 11 can supply power to the load 12. In the case where the FET 20 is off, no current flows between the source and the drain of the FET 20, and the current flowing from the battery 11 to the load 12 is interrupted.

The current mirror circuit 21 includes two PNP bipolar transistors 30 and 31 and two NPN bipolar transistors 32 and 33. Each of the bipolar transistors 30, 31, 32, and 33 has an emitter, a collector and a base as terminals. The emitter of the bipolar transistor 30 is connected to the drain of the FET 20, and the emitter of the bipolar transistor 31 is connected to the other end of the resistor R1. The base of the bipolar transistor 30 is connected to the collector of the bipolar transistor 30 and the base of the bipolar transistor 31.

The collector of the bipolar transistor 30 is further connected to the collector of the bipolar transistor 32. The collector of the bipolar transistor 31 is connected to the base of the bipolar transistor 32, and the collector and the base of the bipolar transistor 33. The emitter of each of the bipolar transistors 32 and 33 is connected to the one end of the resistance circuit 22.

In both of the bipolar transistors 30 and 31, current flows from the emitter to the collector. In both of the bipolar transistors 30 and 31, a resistance value between the emitter and the collector increases as the voltage at the base, which takes the potential at the emitter as a reference, increases. The resistance value between the emitter and the collector decreases as the voltage at the base, which takes the potential at the emitter as a reference, decreases.

The bipolar transistors 30 and 31 have the same or substantially the same characteristics. Accordingly, for both of the bipolar transistors 30 and 31, the resistance value between the emitter and the collector, which corresponds to the voltage at the base that takes the potential at the emitter as a reference, is the same or substantially the same.

Meanwhile, in the bipolar transistors 32 and 33, current flows from the collector to the emitter. In each of the bipolar transistors 32 and 33, a resistance value between the collector and the emitter decreases as the voltage at the base, which takes the potential at the emitter as a reference, increases, and increases as the voltage at the base, which takes the potential at the emitter as a reference, decreases.

The bipolar transistors 32 and 33 also have the same or substantially the same characteristics. Accordingly, for both of the bipolar transistors 32 and 33, the resistance value between the emitter and the collector, which corresponds to the voltage at the base that takes the potential at the emitter as a reference, is the same or substantially the same.

The current mirror circuit 21 configured as described above draws in current from both the source side and the drain side of the FET 20. The values of the two currents drawn in by the current mirror circuit 21 are the same or substantially the same. The current mirror circuit 21 adjusts a value Ic of each of the two drawn-in currents such that the potentials at the emitters of the bipolar transistors 30 and 31 are the same or substantially the same.

A resistance value between the source and the drain of the FET 20, the value of current flowing from the source to the drain of the FET 20, and the resistance value of the resistor R1 in the case where the FET 20 is on are represented by “ron”, “Id”, and “r1”, respectively.

The potentials at the emitters of the bipolar transistors 30 and 31 being the same or substantially the same is equivalent to a voltage value between the source and the drain of the FET 20 and a voltage value between both ends of the resistor R1 being the same or substantially the same. Accordingly, in the case where the FET 20 is on, ron×Id is the same or substantially the same as r1×Ic. To rephrase, the current value Ic matches or substantially matches (ron×Id)/r1.

Accordingly, the current value Ic is proportional to the current value Id, being lower the lower the current value Id is, and higher the higher the current value Id is. In the case where the current value Id is zero amperes or substantially zero amperes, the current value Ic is also zero amperes or substantially zero amperes.

The current mirror circuit 21 outputs a current obtained by combining the two currents drawn in from the source side and the drain side of the FET 20. In the case where the FET 20 is on, the value of the current outputted by the current mirror circuit 21 matches or substantially matches 2×Ic, or in other words, (2×ron×Id)/r1.

The FET 23 also functions as a switch, in the same manner as the FET 20. In the FET 23, current flows from the drain to the source. The FET 23 enters a conductive state and is switched on in the case where the voltage at the gate, which takes a ground potential as a reference, is greater than or equal to a set voltage. Meanwhile, the FET 23 enters a non-conductive state and is switched off in the case where the voltage at the gate, which takes the ground potential as a reference, is less than the set voltage.

In the case where the cancellation signal is at the high-level voltage, the voltage at the gate of the FET 23, which takes the ground potential as a reference, becomes greater than or equal to the set voltage, and the FET 23 is switched on. In the case where the cancellation signal is at the low-level voltage, the voltage at the gate of the FET 23, which takes the ground potential as a reference, becomes less than the set voltage, and the FET 23 is switched off.

The resistance circuit 22 includes a resistor R2. One end of the resistor R2 serves as the one end of the resistance circuit 22, and is connected to the emitters of the bipolar transistors 32 and 33 in the current mirror circuit 21. The other end of the resistor R2 serves as the other end of the resistance circuit 22, and is grounded. Current outputted from the current mirror circuit 21 flows in the resistor R2 of the resistance circuit 22 in the case where the FET 23 and a FET 40 (mentioned later) are off.

A resistance value of the resistor R2 is represented by “r2”. In the case where both the FETs 23 and 40 are off, a voltage value V1 between both ends of the resistance circuit 22 matches or substantially matches (2×ron×r2×Id)/r1 (=2×r2×Ic). The higher the value of the current outputted by the current mirror circuit 21 (2×Ic) is, the higher the voltage value V1 is.

The switching circuit 24 includes a P-channel FET 40, an N-channel FET 41, a diode D1, and resistors R3, R4, R5, and R6. Each of the FETs 40 and 41 has a drain, a source, and a gate as terminals. The source of the FET 40 and one end of the resistor R3 are connected to the positive terminal of the battery 11. The other end of the resistor R3 is connected to the gate of the FET 40 and one end of the resistor R4. The other end of the resistor R4 is connected to the drain of the FET 41, and the source of the FET 41 is grounded.

The gate of the FET 41 is connected to the drain of the FET 23 and the one end of the resistor R2. The drain of the FET 40 is connected to the notifying unit 13, the gate of the FET 20, the anode of the diode D1, and one end of the resistor R5. The other end of the resistor R5 is grounded. The cathode of the diode D1 is connected to one end of the resistor R6, and the other end of the resistor R6 is connected to the gate of the FET 41.

The FET 40 also functions as a switch, and in the FET 40, current flows from the source to the drain. The FET 40 enters a non-conductive state and is switched off in the case where a voltage value at the gate, which takes the potential of the source as a reference, or in other words, a value obtained by subtracting an output voltage value Vb of the battery 11 from a voltage value V2 at the gate that takes the ground potential as a reference, is greater than or equal to a voltage threshold (Vth2−Vb), which is less than zero volts. Meanwhile, the FET 40 enters a conductive state and is switched on in the case where the voltage value at the gate, which takes the potential of the source as a reference, or in other words, the value obtained by subtracting the output voltage value Vb from the voltage value V2, is less than the voltage threshold (Vth2−Vb).

To rephrase, the FET 40 is switched off in the case where the voltage value V2 is greater than or equal to the voltage threshold Vth2, and is switched on in the case where the voltage value V2 is less than the voltage threshold Vth2. The voltage threshold Vth2 is a voltage value less than the output voltage value Vb of the battery 11.

The FET 41 also functions as a switch, and in the FET 41, current flows from the drain to the source. The voltage value V1 is a voltage value between both ends of the resistance circuit 22, and is also a voltage value between the gate and the source of the FET 41. The FET 41 enters a conductive state and is switched on in the case where the voltage value V1 is greater than or equal to a voltage threshold Vth1. The FET 41 enters a non-conductive state and is switched off in the case where the voltage value V1 is less than the voltage threshold Vth1.

The FET 41 is off in the case where the voltage value V1 is less than the voltage threshold Vth1. In the case where the FET 41 is off, no current flows in the resistors R3 and R4, and the voltage value V2 matches or substantially matches the output voltage value Vb of the battery 11. At this time, the voltage value V2 is greater than or equal to the voltage threshold Vth2, and the FET 40 is off. In the case where the FET 40 is off, no current flows in the resistor R5, and thus a voltage value V3 at the drain of the FET 40, which takes the ground potential as a reference, is zero volts or substantially zero volts.

In the FET 20, a voltage value at the gate, which takes the source potential as a reference, can be expressed as (V3−Vb). In the case where the aforementioned predetermined voltage threshold is expressed as (Vth3−Vb), the FET 20 is switched off in the case where the voltage value V3 is greater than or equal to the voltage threshold Vth3, and the FET 20 is switched on in the case where the voltage value V3 is less than the voltage threshold Vth3. The voltage threshold Vth3 is a voltage value less than the output voltage value Vb of the battery 11.

In the case where the voltage value V3 is zero volts or substantially zero volts, the voltage value V3 is less than the voltage threshold Vth3 and the FET 20 is therefore on.

In the case where the voltage value V1 has become greater than or equal to the voltage threshold Vth1, the FET 41 is switched on, and current flows from the positive terminal of the battery 11 to the resistors R3 and R4 and the FET 41 in order. At this time, the resistors R3 and R4 divide the output voltage of the battery 11, and the divided voltage is applied to the gate of the FET 40. At this time, the voltage value V2 becomes less than the voltage threshold Vth2, and the FET 40 is switched on. In the case where the FET 40 has been switched on, current flows from the positive terminal of the battery 11 to the FET 40 and the resistor R5 in order, and the voltage value V3 matches or substantially matches the output voltage value Vb of the battery 11.

In the case where the voltage value V3 matches or substantially matches the output voltage value Vb, the voltage value V3 becomes greater than or equal to the voltage threshold Vth3, and the FET 20 is switched off. The current flowing in the current path from the battery 11 to the load 12 is interrupted as a result.

In the case where the FET 20 has been switched off, the current value Id becomes zero amperes or substantially zero amperes, the current value Ic becomes zero amperes or substantially zero amperes, and the value of the current outputted by the current mirror circuit 21 also becomes zero amperes or substantially zero amperes. Additionally, in the case where the FET 20 is switched off, current flows from the positive terminal of the battery 11 to the FET 40, the diode D1, and the resistors R6 and R2 in order, and the voltage value V1 stays at a voltage value greater than or equal to the voltage threshold Vth1. Accordingly, even in the case where the FET 20 has been switched off and the value of the current outputted by the current mirror circuit 21 has become zero amperes or substantially zero amperes, the FETs 40 and 41 remain on, and the FET 20 remains off.

As described above, in the case where the voltage value V1 has become greater than or equal to the voltage threshold Vth1 while the FET 20 is on, the switching circuit 24 switches the FET 20 from on to off. To rephrase, in the case where the value of the current outputted by the current mirror circuit 21 has become greater than or equal to a current threshold (Vth1/r2) while the FET 20 is on, the switching circuit 24 switches the FET 20 from on to off. The voltage threshold Vth1 corresponds to a second voltage threshold.

A value Ie of the current flowing from the battery 11 to the load 12 is expressed as (Id−Ic), and matches or substantially matches ((r1−ron)×Id)/r1. Accordingly, the current value Id matches or substantially matches (r1×Ie)/(r1−ron). In the case where the FET 20 is on, the voltage value V1 matches or substantially matches (2×ron×r2×Id)/r1, as described earlier. Therefore, the voltage value V1 matches or substantially matches (2×ron×r2×Ie)/(r1−ron). Additionally, the current value Ie matches or substantially matches ((r1−ron)×V1)/(2×ron×r2).

The current value Ie in the case where the voltage value V1 is at the voltage threshold Vth1, or in other words, a current threshold Ieth at which the current flowing in the current path from the battery 11 to the load 12 is interrupted, matches or substantially matches ((r1−ron)×Vth1)/(2×ron×r2). This current threshold Ieth is the aforementioned predetermined value.

Additionally, the current value Id in the case where the voltage value V1 is at the voltage threshold Vth1, or in other words, a current threshold Idth at which the current flowing in the current path from the battery 11 to the load 12 is interrupted, matches or substantially matches (r1×Vth1)/(2×ron×r2).

In the case where the voltage value V1 is greater than or equal to the voltage threshold Vth1 and the FET 20 remains off, when the cancellation signal switches from the low-level voltage to the high-level voltage, the FET 23 switches from off to on and the voltage value V1 becomes less than the voltage threshold Vth1. As a result, the FETs 41 and 40 switch off in that order, the FET 20 switches from off to on, and the off state of the FET 20 is canceled.

As described above, after switching the FET 20 from on to off, the switching circuit 24 keeps the FET 20 off regardless of the value of the current outputted by the current mirror circuit 21. The FET 23 cancels the off state of the FET 20 established by the switching circuit 24. Thus the FET 23 functions as a canceling unit.

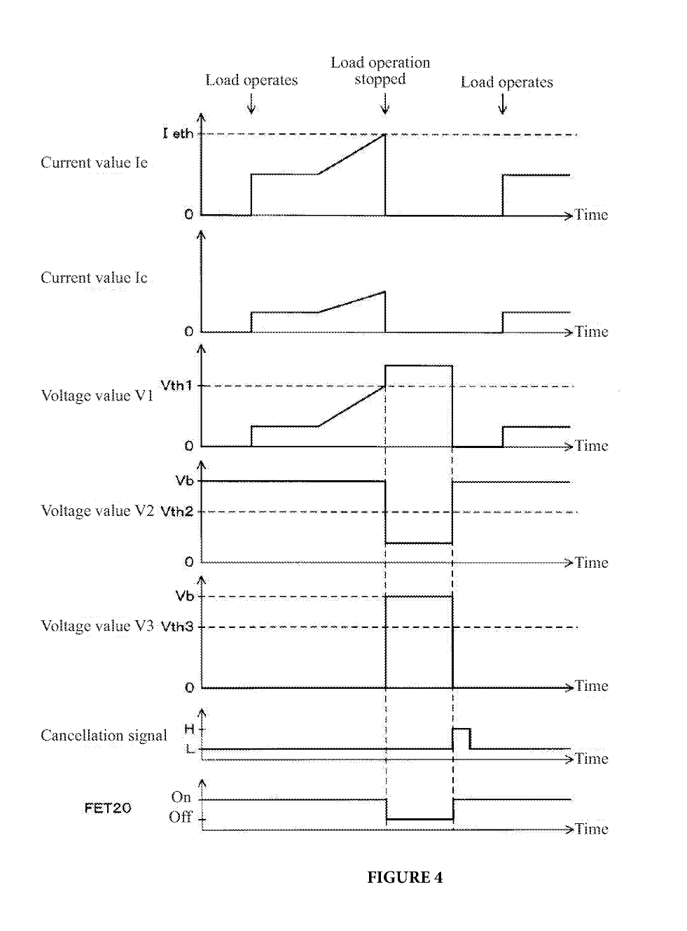

FIG. 4 is a timing chart illustrating operations of the interrupting device 10. FIG. 4 illustrates transitions of the current values Ie and Ic, the voltage values V1, V2, and V3, the cancellation signal, and the on/off switching of the FET 20. In FIG. 4, the high-level voltage is represented by “H” and the low-level voltage is represented by “L”.

With the interrupting device 10, the cancellation signal normally stays at the low-level voltage in the case where the current value Ie is less than the current threshold Ieth. In the case where the current value Ie is less than the current threshold Ieth, the voltage value V1 is less than the voltage threshold Vth1, and thus the FET 41 is off. As a result, the voltage value V2 matches or substantially matches the output voltage value Vb of the battery 11, and is thus greater than or equal to the voltage threshold Vth2. Because the voltage value V2 is greater than or equal to the voltage threshold Vth2, the FET 40 is off, and the voltage value V3 is zero volts or substantially zero volts. Accordingly, the voltage value V3 is less than the voltage threshold Vth3, and thus the FET 20 stays on.

The FET 20 stays on while the current value Ie is less than the current threshold Ieth. The FET 20 therefore stays on while the load 12 is stopped and the current value Ie is zero amperes or substantially zero amperes as well. Furthermore, in the case where the load 12 is operating and the current value Ie exceeds zero amperes as well, the FET 20 stays on while the current value Ie is less than the current threshold Ieth. While the FET 20 is on, the voltage value V3 is zero volts or substantially zero volts, and the switching circuit 24 outputs zero volts or substantially zero volts to the notifying unit 13.

The current value Ic matches or substantially matches (ron×Ie)/(r1−ron), and is lower the lower the current value Ie is, and higher the higher the current value Ie is. Furthermore, in the case where the current value Ie is zero amperes or substantially zero amperes, the current value Ic is also zero amperes or substantially zero amperes. Accordingly, when the load 12 has stopped operating and almost no power is being consumed, the interrupting device 10 also consumes almost no power, and thus the interrupting device 10 has low power consumption.

As described earlier, the voltage value V1 matches or substantially matches (2×ron×r2×Ie)/(r1−ron), and is thus lower the lower the current value Ie is, and is higher the higher the current value Ie is.

Additionally, the FET 20 is a P-channel FET, and thus the FET 20 can be kept on by keeping the voltage between the source and the gate at zero volts or substantially zero volts. As such, it is not necessary to keep the potential at the gate at a higher potential than the potential at the source using a charge pump circuit, for example. The interrupting device 10 has an even lower power consumption as a result.

In the case where the current value Ie has risen due to an abnormality, the current value Ic and the voltage value V1 also rise. In the case where the current value Ie has become greater than or equal to the current threshold Ieth, the voltage value V1 becomes greater than or equal to the voltage threshold Vth1, and the FET 41 is switched on. In the case with FET 41 has been switched on, the voltage value V2 drops to a voltage value less than the voltage threshold Vth2, and the FET 40 is switched on. As a result, the voltage value V3 matches or substantially matches the output voltage value Vb of the battery 11, and is thus greater than or equal to the voltage threshold Vth3. The FET 20 is thus switched off. In the case where the FET 20 has switched off, the current flowing in the current path from the battery 11 to the load 12 is interrupted, and the operation of the load 12 is stopped.

In the case where the FET 20 has switched off, the switching circuit 24 outputs, to the notifying unit 13, a voltage having a value greater than or equal to the voltage threshold Vth3 as the interruption signal indicating the interruption of the current flowing in the current path from the battery 11 to the load 12. In the case where the notifying unit 13 has been inputted with the interruption signal, the notifying unit 13 makes a notification as described earlier. A notification indicating that the current flowing in the current path from the battery 11 to the load 12 has been interrupted can be made as a result.

In the case where the FET 40 has switched from off to on, current flows from the positive terminal of the battery 11 to the FET 40, the diode D1, and the resistors R6 and R2 in order, and the voltage value V1 stays greater than or equal to the voltage threshold Vth1. In the case where the FET 40 has switched from off to on, the current value Ie drops to a current value less than the current threshold Ieth, and the value of the current outputted by the current mirror circuit 21 drops. However, the switching circuit 24 keeps the FET 20 off regardless of the value of the current outputted by the current mirror circuit 21. As a result, the interrupting device 10 can prevent overcurrent from continuing to flow in the current path.

In the case where the cancellation signal has switched from the low-level voltage to the high-level voltage while the FET 20 is off, the voltage value V1 drops to zero volts or substantially zero volts, which is lower than the voltage threshold Vth1, and the FET 41 is switched off. In the case where the FET 41 has been switched off, the voltage value V2 returns to greater than or equal to the voltage threshold Vth2, and the FET 40 is switched off. As a result, the voltage value V3 returns to less than the voltage threshold Vth3, and the FET 20 is once again switched on.

In the case where the load 12 operates again after the cancellation signal has switched from the high-level voltage to the low-level voltage, current flows in the current path from the battery 11 to the load 12, and the current value Ie again becomes a current value greater than or equal to zero amperes.

As described thus far, by canceling the state in which the FET 20 stays off, current can again flow in the current path from the battery 11 to the load 12.

According to the interrupting device 10 configured as described thus far, a configuration in which, in the case where current greater than or equal to the current threshold Ieth flows in the current path from the battery 11 to the load 12, the current flowing in the current path is interrupted, is easily realized using the voltage value V1 between both ends of the resistance circuit 22.

### Second Embodiment

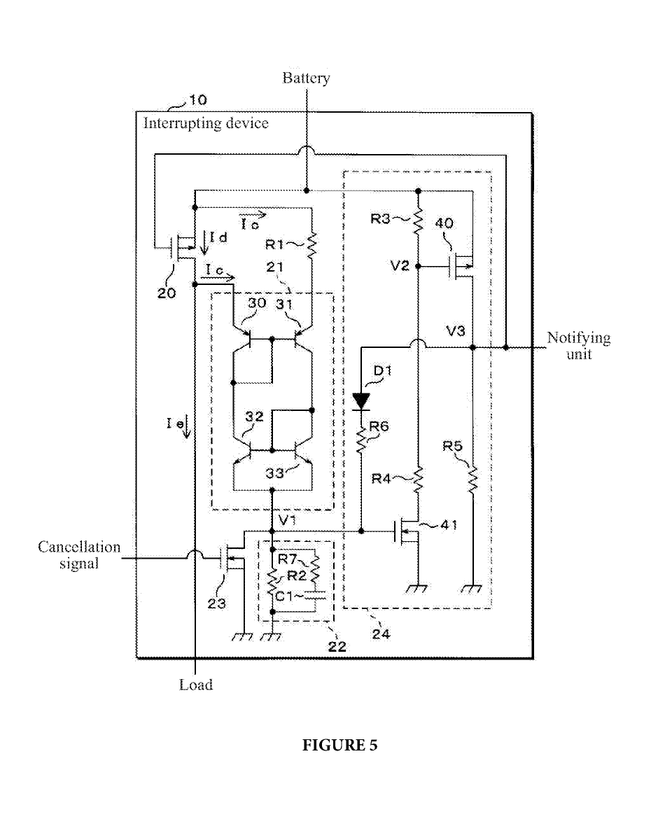

FIG. 5 is a circuit diagram illustrating an interrupting device 10 according to a second embodiment. The interrupting device 10 according to the second embodiment differs from the interrupting device 10 according to the first embodiment in terms of the configuration of the resistance circuit 22.

A load to which a large current is temporarily supplied during operation can be considered as the load 12. The interrupting device 10 according to the second embodiment is a device in which the FET 20 is unlikely to erroneously turn off even in the case where a large current flows in the current path from the battery 11 to the load 12 temporarily while the load 12 is operating.

Hereinafter, points of the second embodiment that are different from the first embodiment will be described. Configurations aside from those described hereinafter are the same as in the first embodiment, and will thus be given the same reference numerals, and detailed descriptions thereof will be omitted.

The resistance circuit 22 according to the second embodiment includes a capacitor C1 and a resistor R7 in addition to the resistor R2. One end of the resistor R7 is connected to the current mirror circuit 21-side end of the resistor R2, and the other end of the resistor R7 is connected to one end of the capacitor C1. The other end of the capacitor C1 is grounded. In this manner, a series circuit constituted of the capacitor C1 and the resistor R7 is connected in parallel to the resistor R2. The resistors R2 and R7 function as a first resistor and a second resistor, respectively.

In the case where the power stored in the capacitor C1 is zero watts, the resistance value of the resistance circuit 22 is substantially the resistance value of a parallel circuit formed by the resistor R2 and the resistor R7 connected in parallel. This resistance value is lower than the resistance value of the resistor R2. The resistance value of the resistance circuit 22 rises as the power stored in the capacitor C1 increases. An upper limit value of the resistance value of the resistance circuit 22 is the resistance value of the resistor R2.

The resistance value of the resistance circuit 22 is represented by “rt”. Current outputted by the current mirror circuit 21 flows in the resistance circuit 22. In the case where the value of the current outputted by the current mirror circuit 21 is greater than or equal to a current threshold (Vth1/rt), the FET 41 is switched on, and the switching circuit 24 switches the FET 20 off. Accordingly, in the case were the resistance value rt of the resistance circuit 22 is low, the FET 20 will not turn off even if a large current is outputted from the current mirror circuit 21. In other words, the current threshold Ieth is greater the lower the resistance value rt of the resistance circuit 22 is, and is lower the greater the resistance value rt is.

In the case where the value of the current outputted by the current mirror circuit 21 is less than the current threshold (Vth1/rt), the FET 41 is switched off, and the switching circuit 24 switches the FET 20 on.

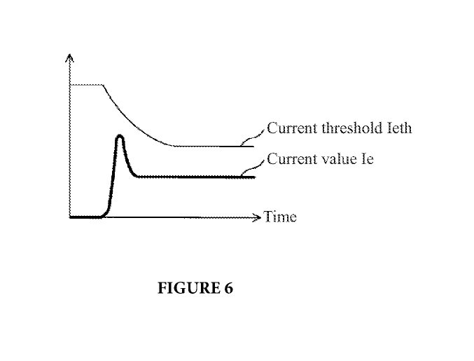

FIG. 6 is a timing chart illustrating effects of the resistance circuit 22. In FIG. 6, transitions of the current value Ie are indicated by a bold line, whereas transitions of the current threshold Ieth are indicated by a narrow line. In the case where the current value Ie is zero amperes or substantially zero amperes and the current mirror circuit 21 is not outputting current, the capacitor C1 discharges and thus little power is stored in the capacitor C1. The current threshold Ieth is therefore high.

In the case where the load 12 operates and current begins to flow from the battery 11 to the load 12, the current mirror circuit 21 also begins to output current, and power is stored in the capacitor C1. As the power stored in the capacitor C1 rises, the current threshold Ieth drops.

The current threshold Ieth is sufficiently high during the period when the load 12 operates and a large current is temporarily supplied, and thus the voltage value V1 does not become greater than or equal to the voltage threshold Vth1, and the FET 20 remains on. Thus even in the case where the load 12 operates and a large current temporarily flows in the current path from the battery 11 to the load 12, the voltage value V1 will not become greater than or equal to the voltage threshold Vth1, and the FET 20 will not be switched off.

The interrupting device 10 according to the second embodiment has the same configuration as the interrupting device 10 according to the first embodiment, with the exception of the series circuit constituted of the capacitor C1 and the resistor R7 being connected to the resistor R2. Thus the interrupting device 10 according to the second embodiment achieves the same effects as the interrupting device 10 according to the first embodiment.

In the first and second embodiments, the values of the two currents drawn in by the current mirror circuit 21 from the source and the drain of the FET 20 need not be the same or substantially the same. The current mirror circuit 21 may draw in a current from the source of the FET 20 having a value that is a predetermined multiple of the value of the current drawn in from the drain of the FET 20. Additionally, the current mirror circuit 21 is not limited to a circuit constituted using the bipolar transistors 30, 31, 32, and 33. The current mirror circuit 21 may be any circuit that draws in two currents, having values that are greater the greater the current value Id is, from the source and the drain, respectively, of the FET 20, and that outputs a current obtained by combining the two drawn-in currents.

Additionally, a PNP bipolar transistor may be used instead of the FET 20. Furthermore, in the switching circuit 24, a PNP bipolar transistor may be used instead of the FET 40, and an NPN bipolar transistor may be used instead of the FET 41.

It is sufficient that the FET 23 function as a switch, and thus the FET 23 is not limited to an N-channel FET. The FET 23 may be a P-channel FET. Furthermore, a bipolar transistor may be used instead of the FET 23. The first and second embodiments disclosed here are intended to be in all ways exemplary and in no ways limiting. The scope of the present invention is defined not by the foregoing descriptions but by the scope of the claims, and is intended to include all changes equivalent in meaning to and falling within the scope of the claims.

1. An interrupting device that, in the case where a current greater than or equal to a predetermined value flows in a current path, interrupts the current flowing in the current path, the device comprising:
a switch provided in the current path;
a current mirror circuit that draws in a current from each of one end and another end of the switch and outputs a current obtained by combining the two drawn-in currents; and
a switching circuit that switches the switch off in the case where a value of the current outputted from the current mirror circuit is greater than or equal to a current threshold,
wherein a value of each of the two currents drawn in by the current mirror circuit is higher the higher a value of the current flowing in the switch is.

2. The interrupting device according to claim 1,
wherein the switching circuit is configured to keep the switch off after switching the switch off regardless of the value of the current outputted by the current mirror circuit; and
the interrupting device further comprises:
a canceling unit that cancels the off state the switch is kept in.

3. The interrupting device according to claim
wherein the switch is a transistor, and is configured to enter a non-conductive state in the case where a voltage value at a control terminal that takes a potential at a current input terminal as a reference is greater than or equal to a voltage threshold less than zero, and to enter a conductive state in the case where the voltage value at the control terminal is less than the voltage threshold.

4. The interrupting device according to claim 1, further comprising:
a resistance circuit, including at least one resistor, in which the current outputted by the current mirror circuit flows,
wherein the switching circuit is configured to switch the switch off in the case where a voltage value at both ends of the resistance circuit is greater than or equal to a second voltage threshold.

5. The interrupting device according to claim 4,
wherein the resistance circuit includes:
a first resistor; and
a series circuit, constituted of a second resistor and a capacitor, connected in parallel to the first resistor.

6. The interrupting device according to claim 1,
wherein the switching circuit is configured to output an interruption signal indicating the interruption of the current flowing in the current path in the case where the switch has been switched off.

7. The interrupting device according to claim 2, wherein the switch is a transistor, and is configured to enter a non-conductive state in the case where a voltage value at a control terminal that takes a potential at a current input terminal as a reference is greater than or equal to a voltage threshold less than zero, and to enter a conductive state in the case where the voltage value at the control terminal is less than the voltage threshold.

8. The interrupting device according to claim 2, further comprising:
a resistance circuit, including at least one resistor, in which the current outputted by the current mirror circuit flows,
wherein the switching circuit is configured to switch the switch off in the case where a voltage value at both ends of the resistance circuit is greater than or equal to a second voltage threshold.

9. The interrupting device according to claim 3, further comprising:
a resistance circuit, including at least one resistor, in which the current outputted by the current mirror circuit flows,
wherein the switching circuit is configured to switch the switch off in the case where a voltage value at both ends of the resistance circuit is greater than or equal to a second voltage threshold.

10. The interrupting device according to claim 2, wherein the switching circuit is configured to output an interruption signal indicating the interruption of the current flowing in the current path in the case where the switch has been switched off.

11. The interrupting device according to claim 3, wherein the switching circuit is configured to output an interruption signal indicating the interruption of the current flowing in the current path in the case where the switch has been switched off.

12. The interrupting device according to claim 4, wherein the switching circuit is configured to output an interruption signal indicating the interruption of the current flowing in the current path in the case where the switch has been switched off.

13. The interrupting device according to claim 5, wherein the switching circuit is configured to output an interruption signal indicating the interruption of the current flowing in the current path in the case where the switch has been switched off.
